(19) United States
(12) Patent Application Publication
(10) Pub. No.: US 2008/0231213 A1
(43) Pub. Date: Sep. 25, 2008

(54) LED String Lights

(76) Inventor: Xuliang Li, Dongguan (CN)

Correspondence Address: GLOBAL IP SERVICES, 7285 W. Eagle Court, Winton, CA, 95388, US

(21) Appl. No.: 11/830,151

(22) Filed: Jul. 30, 2007

(30) Foreign Application Priority Data
Mar. 21, 2007 (CN) 200720119034.8

(51) Int. Cl. H05B 37/02

(52) U.S. Cl. 315/297

(57) ABSTRACT

The invention herein relates to a decorative light, and, more particularly, to a LED (light-emitting diode) string lights with a current-limiting device. The LED string lights comprises a plug, a plurality of leads and a plurality of LED bulbs. Said LED string lights further comprises a current-limiting device connecting to said LED bulbs in series. Said current-limiting device comprises a resistor and a shell encapsulating said resistor therein. Said shell is an assembled structure with two contact pieces fixed inside. Said resistor connects to said two contact pieces through two legs of said resistor respectively and said two contact pieces connect to leads respectively to form a circuit. The present invention provides a LED string lights with low manufacturing cost, simple manufacturing technics and great working reliability.

### CROSS REFERENCE TO RELATED PATENT APPLICATION

This application claims the priority of the Chinese patent application No. 200720119034.8, filing date of Mar. 21, 2007.

### FIELD OF THE INVENTION

The invention herein relates to a decorative light, and, more particularly, to a LED (light-emitting diode) string lights with a current-limiting device.

### BACKGROUND OF THE INVENTION

Decorative lights are frequently used in daily life. Various decorative string lights are used in Christmas lights and building decoration especially in festivals. Conventionally, a current-limiting resistor of the LED string lights is installed by welding it to the LED legs or connecting it into the lead circuit in series, and then sealed by using sealant injection, heat-shrinkable tube or injection. Such technology was disclosed in Chinese patent No. 200320118696.5 titled “a LED bulb string lights”. Firstly, because the resistor is a heating element, the fixing-strength of its tin connection points will decrease when the temperature of the resistor increases, then the resistor will disengage from the circuit and furthermore bring in certain fault. Secondly, each LED bulb needs one current-limiting resistor to be fixed thereof, which brings in not only high material cost but also complicated production process and high manufacturing cost.

### SUMMARY OF THE INVENTION

The present invention is intent to overcome the deficiency of prior arts and provide a LED string lights with low manufacturing cost, simple manufacturing technics and great working reliability.

The intention of the present invention could be achieved by following measures:

A LED string lights comprises a plug, a plurality of leads, and a plurality of LED bulbs. Said LED string lights further comprises a current-limiting device connecting to said LED bulbs in series. Said current-limiting device comprises a resistor and a shell encapsulating said resistor therein. Said shell is an assembled structure with two contact pieces fixed inside. Said resistor connects to said two contact pieces through two legs of said resistor respectively and said two contact pieces connect to leads respectively to form a circuit.

Said shell comprises a cylindraceous main body and a cylindraceous lid with one end closed. Said main body comprises an inner core which integrates with said resistor to form one component to be mounted inside said shell together. Said legs of said resistor pass though leg holes of said inner core and then bend backwardly to contact with said contact pieces. A side of said lid that faces to said main body comprises a hook and a side of said main body that faces to said lid comprises a hook portion, and said hook buckles with said hook portion to firmly integrate said lid and said main body together when said lid enters into said main body.

A temperature control insurance is connected between said resistor and one of said contact pieces in series. Said temperature control insurance, said resistor and said inner core are assembled together and put inside said shell.

Said LED string lights further comprises a tail receptacle receiving said plug of next LED string lights. Said tail receptacle comprises output jacks and two input leads connecting with two electrical-source leads of said plug of said LED string lights respectively.

The current-limiting resistor of the LED string lights of this invention is encapsulated in the separated shell. Each current-limiting device connects to at least two LED bulbs in series and even a whole LED string lights only has one current-limiting resistor. This decreases the amount of the resistors and the welding points. And the temperature control insurance could also be set inside the shell. Therefore, compared with the prior art, the working reliability of the LED string lights greatly increases. The decrease of the amount of the resistors not only saves the materials, but also simplifies the manufacturing technics and decreases the manufacturing cost.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

FIG. 1 is a schematic view of a first embodiment of the present invention;

FIG. 2 is a cross-sectional view of the current-limiting device in accordance with the first embodiment of the present invention;

FIG. 3 is a schematic view of a second embodiment of the present invention.

### DETAILED DESCRIPTION OF ILLUSTRATED EMBODIMENTS

The present invention will now be described with reference to the drawings:

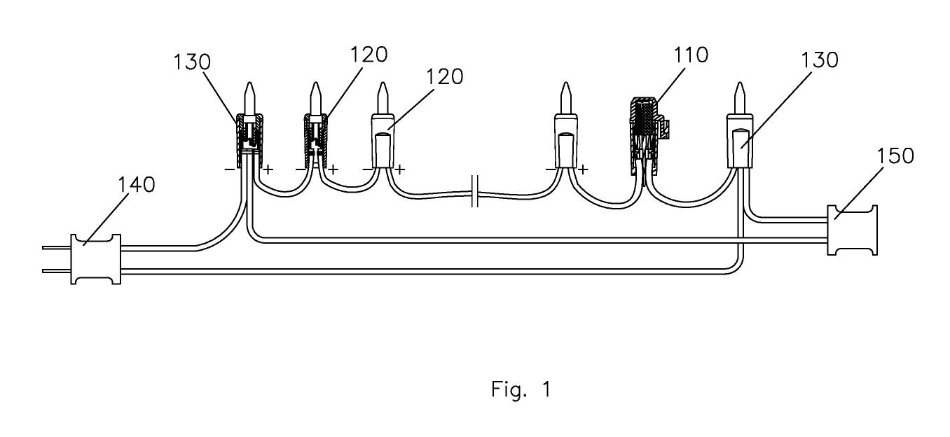

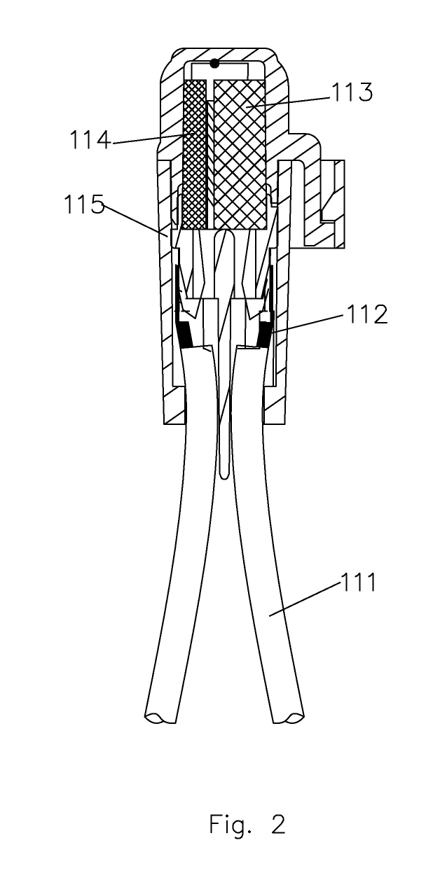

Referring to FIG. 1 and FIG. 2, a LED string lights with a tail receptacle in accordance with a first embodiment of the present invention comprises a plug 140, leads, twenty LED bulbs 120 and a current-limiting device 110. The current-limiting device 110 comprises a resistor 113 and a shell 115 which encapsulates the resistor 113 therein. The shell 115 is an assembled structure. Two contact pieces 112 are fixed inside the shell 115. The resistor 113 connects to said two contact pieces 112 through its two legs thereof respectively. Said two contact pieces 112 connect to two leads 111 respectively to form a circuit. Only one current-limiting device 110 is assembled in the LED string lights. The shell 115 comprises a cylindraceous main body and a cylindraceous lid with one end closed. The main body includes an inner core, which integrates with the resistor 113 to form one component to be mounted inside the shell 115 together. The legs of the resistor 113 pass though leg holes of the inner core and then bend backwardly to contact with said contact pieces 112. A side of said lid that faces to the main body has a hook and a side of said main body that faces to the lid has a hook portion. Said hook buckles with said hook portion to firmly integrate the lid and the main body together when the lid enters into the main body. In this embodiment, a temperature control insurance 114 is connected between the resistor 113 and one of the contact pieces 112 in series. The temperature control insurance 114, the resistor 113 and the inner core are assembled together and put inside the shell 115. In this embodiment, twenty LED bulbs 120 connect in series, and current-limiting device 110 also connects with the LED bulbs 120 in series. The LED string lights of this embodiment further includes a tail receptacle 150 receiving the plug of next LED string lights. The tail receptacle 150 has output jacks and two input leads connecting with two electrical-source leads of the plug 140 of the LED string lights respectively. The first LED bulb and the last LED bulb of the LED string lights are LED bulbs 130 that each connects with three leads. One of the contact pieces of said LED bulb 130 connect with two leads. Referring to FIG. 1, one of said two leads connects with the plug 140, and the other one connects with the tail receptacle 150. The other contact piece of said LED bulb 130 connects with one lead which connects with other LED bulb. In this embodiment, the current-limiting device 110 is connected between the last LED bulb 130 and the bulb 120 nearby the last LED bulb 130. In operation, the current-limiting device 110 limits the current of the whole LED string lights.

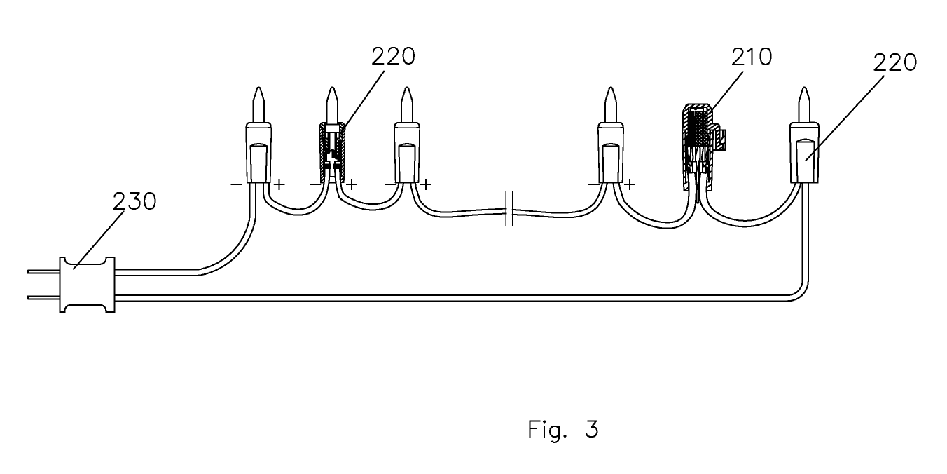

Referring to FIG. 3, a LED string lights with a current-limiting device in accordance a second embodiment of the present invention comprises twenty LED bulbs connecting in series, a current-limiting device, a plug and leads. The difference between the first embodiment and the second embodiment is that the second embodiment doesn't include a tail receptacle. All of the LED bulbs of the second embodiment only have two leads.

What is claimed is:

1. A LED string lights, comprising:
a plug;
a plurality of leads; and
a plurality of LED bulbs;
wherein said LED string lights further comprises a current-limiting device connecting to said LED bulbs in series, said current-limiting device comprising a resistor and a shell encapsulating said resistor therein, said shell being an assembled structure with two contact pieces fixed inside, said resistor connecting to said two contact pieces through two legs of said resistor respectively and said two contact pieces connecting to leads respectively to form a circuit.

2. The LED string lights of claim 1, wherein said shell comprises a cylindraceous main body and a cylindraceous lid with one end closed, said main body comprising an inner core which integrates with said resistor to form one component to be mounted inside said shell together, said legs of said resistor passing though leg holes of said inner core and then bending backwardly to contact with said contact pieces, a side of said lid that faces to said main body comprising a hook and a side of said main body that faces to said lid comprising a hook portion, and said hook buckling with said hook portion to firmly integrate said lid and said main body together when said lid enters into said main body.

3. The LED string lights of claim 2, wherein a temperature control insurance is connected between said resistor and one of said contact pieces in series, said temperature control insurance, said resistor and said inner core being assembled together and put inside said shell.

4. The LED string lights of claim 1, wherein said LED string lights further comprises a tail receptacle receiving said plug of next LED string lights, said tail receptacle comprising output jacks and two input leads connecting with two electrical-source leads of said plug of said LED string lights respectively.
